(19) United States
(12) Patent Application Publication
(10) Pub. No.: US 2006/0191832 A1
(43) Pub. Date: Aug. 31, 2006

(54) Dual media fuel filter and fuel/water separator cartridge filter system

(76) Inventors: Bryant L. Richie, Chillicothe, IL (US); Jeffery R. Ries, Metamora, IL (US); Philip C. Spengler, Washington, IL (US)

Correspondence Address: CATERPILLAR INC.;100 N.E. ADAMS STREET, PATENT DEPT., PEORIA, IL, 616296490, US

(21) Appl. No.: 11/353,543

(22) Filed: Feb. 14, 2006

Related U.S. Application Data
(60) Provisional application No. 60/652,627, filed on Feb. 14, 2005.

(51) Int. Cl. B01D 27/00

(52) U.S. Cl. 210/171; 210/338; 210/416.4

(57) ABSTRACT

A fuel filter system which includes both a fuel filter and fuel/water separator media in a single sytem. Fuel passes from a tank or other source into the canister. The fuel flows first through the fuel/water separator element. The fuel then exist the canister to the suction side of a fuel transfer pump. The outlet side of the fuel transfer pump sends the fuel back into the canister where it passes through the fuel filter element. The fuel/water separator element and the fuel filter element are combined in a single cartridge.

### This patent application claims the benefit of U.S. Provisional patent application no. 60/652,627, filed Feb. 14, 2005.

### TECHNICAL FIELD

The field of this invention is the filtration of fluids. More specifically, this invention is directed to the filtration of liquid fuels, such as diesel or gasoline, and the separation of water from such fuels, all in a single filter system.

### BACKGROUND

Filters for filtering fuels and other fluids are known.

### BRIEF DESCRIPTION OF THE DRAWINGS

FIG. 1 is a diagrammatic view of a fuel filter system.

FIG. 2 is sectional view of a fuel filter system.

FIG. 3 is an isometric view of the end cap from FIG. 2.

FIG. 4 is a top view of the end cap of FIG. 3.

FIG. 5 is an isometric view of the outer center tube from FIG. 2.

FIG. 6 is an isometric view of the inner center tube from FIG. 2.

FIG. 7 is an isometric view of the assembled cartridge from FIG. 2.

FIG. 8 is an isometric view of the fuel filter system of FIG. 2.

### DETAILED DESCRIPTION

The following is a detailed description of exemplary embodiments of the invention. Description of these exemplary embodiments is intended to teach the principles and applications of the invention. The exemplary embodiments described and illustrated herein should not be considered as a limiting description of the intended scope of the invention. The intended scope of the invention will be set forth in the claims.

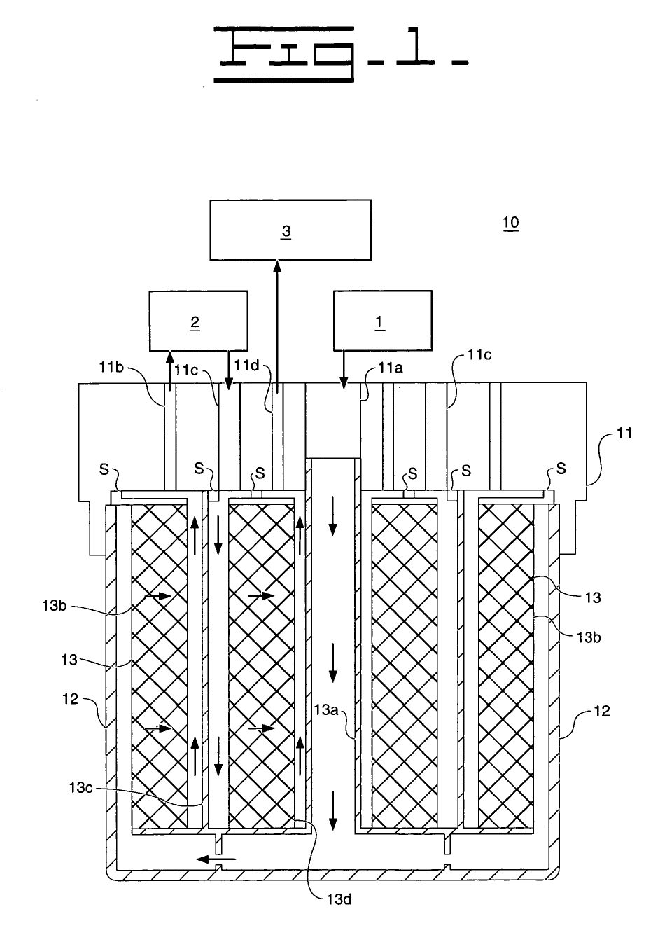

FIG. 1 illustrates several principles of the invention in diagrammatic form. In FIG. 1, a fuel filter system 10 comprises a filter base 11, a canister 12, and a cartridge 13. Canister 12 is removably attached to the filter base 11 with threads in a conventional manner, and cartridge 13 is positioned inside of canister 12. Canister 12 and filter base 11 act to direct the flow of fluid through the cartridge 13 in the correct direction and without substantial leakage. The filtration and fuel/water separation takes place in the cartridge 13. The cartridge 13 should be replaced periodically as it deteriorates or becomes charged and clogged with filtered-out foreign matter. The cartridge 13 is replaced by unthreading and detaching canister 12 from filter base 11. Then cartridge 13 can be removed and properly discarded, and a fresh cartridge 13 inserted in its place. The canister 12 is then rethreaded and attached to the filter base 11.

Fuel flow through the system originates with fuel flowing from a fuel tank 1, or other fuel source, through a port 11a in the filter base 11 and into an inner center tube 13a. The fuel next flows down and underneath the cartridge 13 to the outer perimeter surface thereof. The fuel flows through a first filter element, having a fuel water separator (FWS) media 13b, then exits the cartridge 13 through a port 11b in the filter base 11. The port 11b ultimately leads to the suction side of a fuel transfer pump 2. Thus, the fuel passing through the port 11a, through the inner center tube 13a, and through the FWS media 13b is under suction and at a low absolute pressure compared to the rest of the system, and may even be below atmospheric pressure.

Fuel transfer pump 2 then pumps the fuel back into the filter base 11, through port 11c, and into the cartridge 13. The cartridge 13 includes an outer center tube 13c which separates and prevents flow directly between the FWS media 13b and a filter media 13d. Fuel passing from the pump 2 and through port 11c will enter the space between the outer center tube 13c and the filter media 13d. The fuel passes through and is filtered by a second filter element, having the filter media 13d, then exits the cartridge 13 through port 11d.Port 11d carries the fuel towards an engine, and possibly to a high pressure fuel system pump for a fuel injection system. Thus, the fuel passing through port 11c, through filter media 13d, and through port 11d towards an engine is under pressure and at an elevated absolute pressure compared to the rest of the system, and may also be above atmospheric pressure.

The fuel filter system 10 of FIG. 1 contains both a pressure side second filter element (filter media 13d) and a suction side first filter element (FWS media 13b) in one single replaceable cartridge. The pressure side filter element is located, in general, radially inward of and inside the suction side filter element. With this construction, if pressurized fluid should leak out of the region surrounding the pressure side filter element, it will leak into and be suctioned-up by the pump from the region surrounding the suction side filter element. O-ring seals S integrally formed with and on the cartridge 13 seal against the filter base 11 and ensure that the pressure of one region of the cartridge does not leak into other regions of the filter.

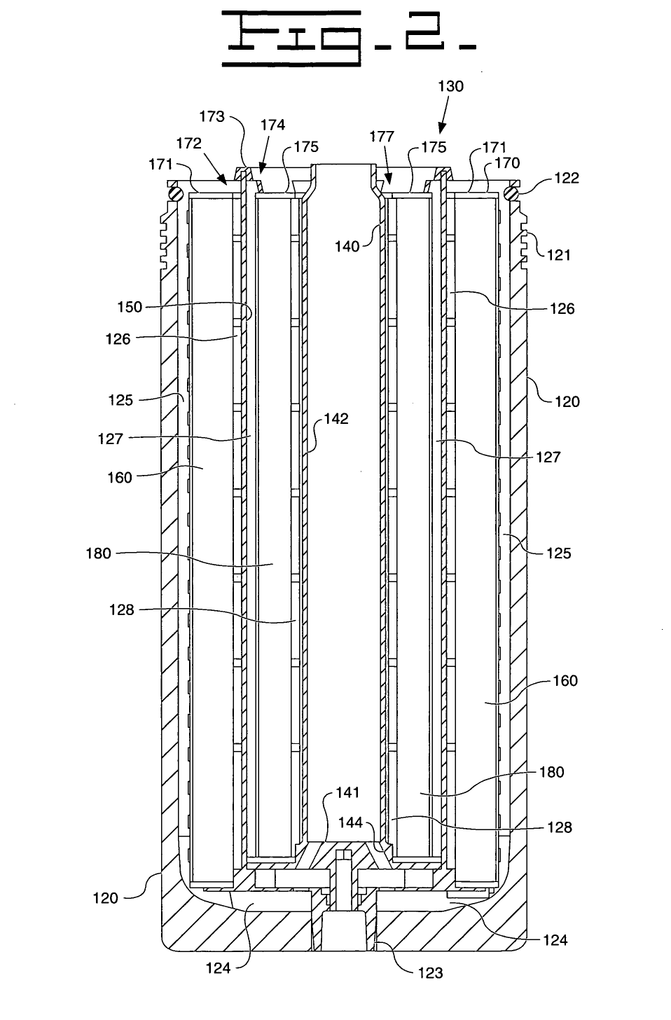

FIGS. 2-8 illustrate a fuel filter system having a greater level of detail than the system diagrammatically illustrated in FIG. 1. The system of FIGS. 2-8 also includes additional details not shown in the system of FIG. 1. Nevertheless, the principles of the invention illustrated through the system of FIG. 1 are equally applicable to the system in FIGS. 2-8.

Turning now to FIG. 2, a cartridge 130 and a canister 120 are shown. The cartridge 130 and canister 120 are intended to interface with a filter base similar to filter base 11 of FIG. 1. Although the filter base for this system is not shown, it will be within the level of those of ordinary skill in this art to construct a filter base with the appropriate ports, sealing surfaces, and threads for interacting with the cartridge 130 and canister 120. The cartridge 130 and canister 120 are shown in sectional view, the view being taken from a planar, vertical cut through the center of the canister 120, in order to shown the internal components thereof.

Canister 120 includes exterior threads 121 and an O-ring 122. The threads 121 will correspond to threads on the filter base in a conventional manner so that canister 120 can be securely attached to the filter base. O-ring 122 will press against both the canister 120 and the filter base in order to form a seal and prevent fluids from leaking outside canister 120. Canister 120 also includes an opening 123 at the bottom thereof for a drain plug (not shown). p Fuel flow through the system originates with fuel flowing from a fuel tank, or other fuel source, through the filter base (not shown) and into an inner center tube 140. Inner center tube 140 is also illustrated isometrically in FIG. 6. Center tube 140 includes a base plate portion 141 and a tube portion 142. Base plate portion 141 includes multiple ports 144 passing from the interior of the tube portion 142, and through the base plate portion 141. Ports 144 permit fuel to flow from inside the inner center tube 140, to a region 124 beneath cartridge 130. Fuel then flows from region 124 around the edge of an outer center tube 150, and into annular region 125. Region 125 circumferentially surrounds a first filter element having a fuel/water separator (FWS) media 160. Fuel then flows through the FWS media 160, where water is separated out into droplets along the surface of the media in a conventional manner. The water droplets, being heavier than the fuel, are permitted to fall down into region 124 where they pool at the bottom of the canister 120. A drain plug (not shown) can be provided in opening 123 to allow for selective opening and draining of the water, and for draining the fuel out of canister 120 before changing the cartridge 130.

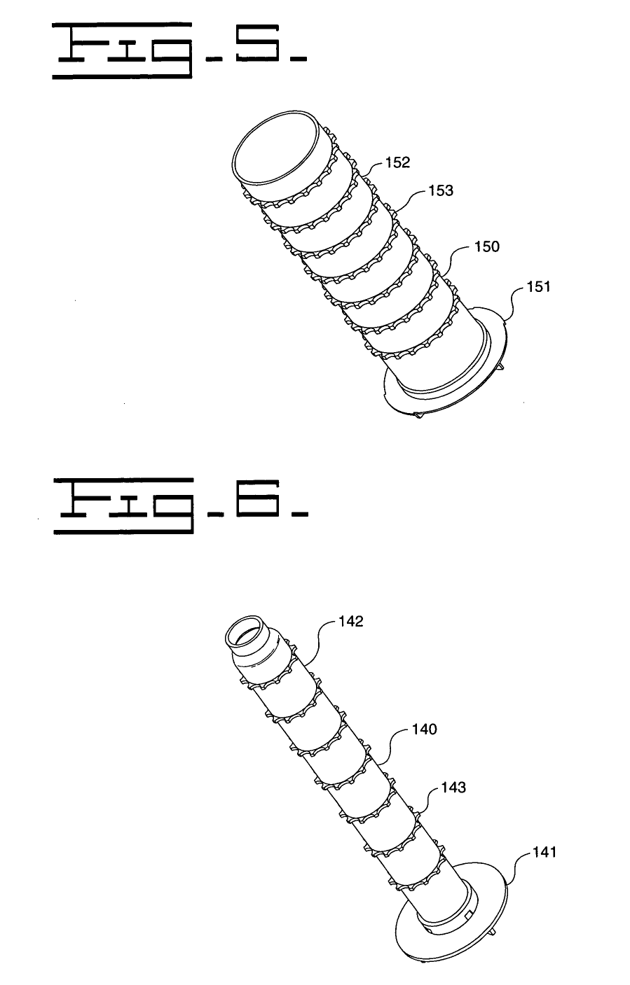

The fuel flows entirely through FWS media 160 then exits into an annular region 126 located radially between the inside surface of the FWS media 160 and the outer center tube 150. An isometric view of outer center tube 150 is shown in FIG. 5. Outer center tube 150 includes a base plate portion 151 and a tube portion 152. FWS media 160 circumferentially surrounds the tube portion 142, and rests and seals against the base plate portion 151. Outer center tube 150 also includes indentations or raised portions 153. The raised portions 153 ensure that a space, region 126, is created and maintained between the FWS media 160 and the tube portion 152.

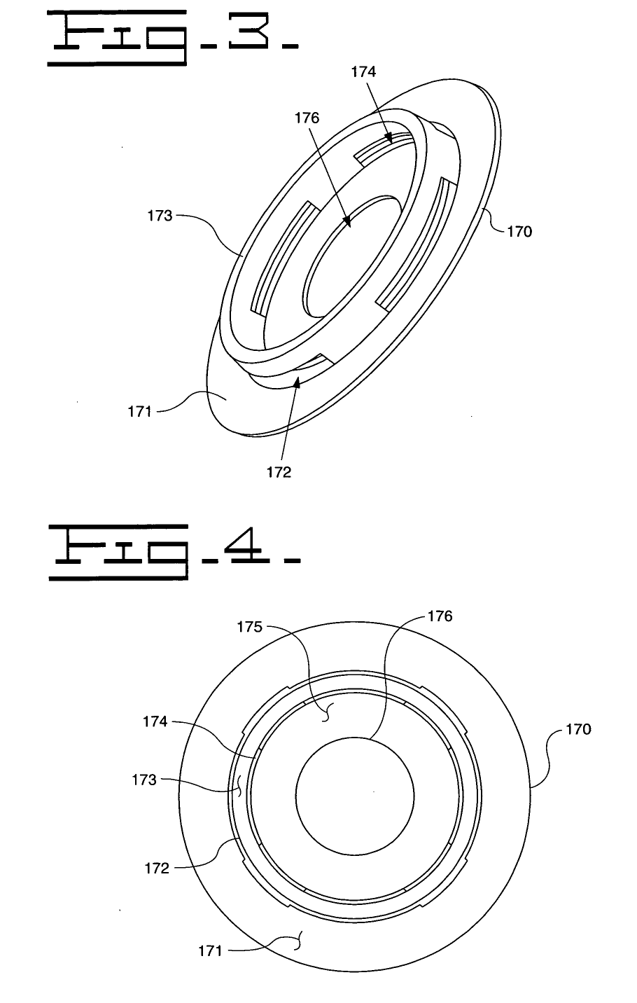

Fuel then flows up through region 126 towards end cap 170. End cap 170 is shown in an isometric view in FIG. 3, and in a top view in FIG. 4. End cap 170 includes an annular outer plate 171 which buts against the top of FWS media 160. End cap 170 also include a first annular port 171 for fuel from region 126 to flow through and into the filter base (not shown). The fuel then flows out through the filter base to the suction side of a fuel transfer pump (not shown). Thus, the fuel in region 126, in FWS media 160, in regions 125 and 124, and inside the tube portion 142 of inner center tube 140 is under suction and at a low absolute pressure compared to the rest of the system, and may even be below atmospheric pressure.

From the outlet, or high pressure side, of the fuel transfer pump, the fuel passes again through the filter base and through a second annular port 174. First annular port 172 and second annular port 174 are separated by a V-shaped portion 173 which engages with the top of the tube portion 152 of outer center tube 150. The engagement of the tube portion 152 with the V-shaped portion 173 fluidly separates the first annular port 172 and the second annular port 174. Fuel flows through the second annular port 174 into an annular region 127. Fuel is prevented from passing back into region 126 by the impermeable outer center tube 150.

Region 127 circumferentially surrounds a filter media 180. Filter media 180 is conventional and acts to trap and retain harmful foreign particles in the fuel that passes therethrough. Filter media 180 circumferentially surrounds tube portion 142 of inner center tube 140, and the bottom of filter media 180 buts and seals against the plate portion 141. Plate portion 141 at its radially outermost surface buts against the inside of tube portion 152 of the outer center tube 150 to prevent fuel from passing from region 127 to region 124. The fuel passes through the filter media 180 into an annular region 128. Tube portion 142 includes indentations or raised portions 143. The raised portions 143 ensure that a space, region 128, is created and maintained between the filter media 180 and the tube portion 142.

Fuel then flows up through region 128. End cap 170 includes a annular inner plate 175. The top of the filter media 180 abuts and seals against the annular inner plate 175. An opening 175 is formed in the annular inner plate 175 in which the top end of the tube portion 142 of the inner center tube may be positioned. Between the top end of the tube portion 142 and the annular inner plate 175, a third annular port 177 is formed for the fuel from region 128 to pass through. Fuel passes through third annular port 177 and into the filter base (not shown). From there, the fuel is carried to the engine, and possibly to a high pressure fuel system pump for a fuel injection system.

From the outlet, or high pressure side of the fuel transfer pump, the fuel located in second annular port 174, region 127, filter media 180, region 128, and third annular port 177 is under pressure and at an elevated absolute pressure compared to the rest of the system, and may also be above atmospheric pressure.

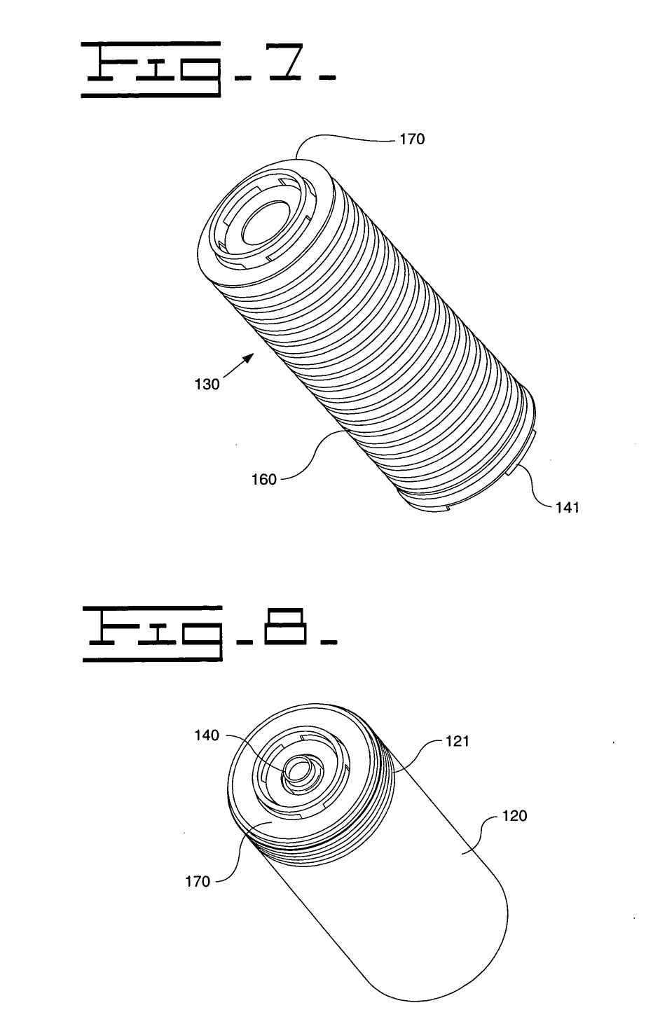

FIG. 7 illustrates the assembled cartridge 130, except that the inner center tube 140 of cartridge 130 is not included. FIG. 8 shows the cartridge 130 (this time including inner center tube 140) positioned inside canister 120.

A series of seals, for example O-ring seals, should be arranged between the end cap 170 and the filter base. The seals will prevent fuel in one region in the cartridge 130 from leaking into other regions by passing between the end cap 170 and the filter base. As with the seals S illustrated diagrammatically in FIG. 1, the seals may be integrally formed with or on the end cap 170 and in similar positions.

Even if the fuel in one relatively high pressure region leaks through the seals into a region of relatively low pressure, the leaked fuel will simply be drawn up by the suction of the fuel transfer pump and reintroduced into the proper flow of the system. Thus the danger of a leak from the relatively high pressure regions surrounding the filter media 180 is reduced because the leak will be contained in the relatively low pressure regions surrounding the FWS media 160.

### INDUSTRIAL APPLICABILITY

The filter systems shown in FIGS. 1-9 can be used to filter fuel and other fluids in industrial equipment such as engines. Although the systems described above are specifically for fuel systems, the design and principles could be equally applied to filtering other fluids such as lubricating oils, hydraulic fluids for motion and power transfer or control, or transmission fluids for a transmission.

The benefits of the systems in FIGS. 1-9 include the following: A single canister and filter base can be used for two filter elements (such as a FWS and a fuel filter, or if used with a lubricating oil system, a course particle filter and a fine particle filter) which reduces the cost. Otherwise a separate canister and filter base would be needed for each separate filter element. Two filter elements can be serviced and replaced in a single operation, saving time and complexity. The pressurized region of the filter system is in the center of a lower pressure region, so that there are no seals directly between the high pressure region and the environment which minimizes the risk of high pressure leaks.

We claim:

1. A filter system comprising:
a pump
a filter base;
a filter canister attached to the filter base;
a cartridge positioned inside the canister, the cartridge including a first filter element, and a second filter element;
a fuel path leading from the filter base, through the first filter element, through the filter base to the pump, from the pump through the filter base, through the second filter element, and exiting through the filter base.

2. A filter system according to claim 1 wherein the first filter element includes fuel/water separator media, and the second filter element includes fuel filter media.

3. A filter system according to claim 1 wherein:
the first filter element is annular shaped;
the second filter element is annular shaped; and
the second filter element is positioned radially inside of the first filter element.

4. A filter system according to claim 1 wherein the fuel in the fuel path before the pump is at a pressure lower than an atmospheric pressure measured outside of the canister, and the fuel in the fuel path after the pump is at a pressure higher than the atmospheric pressure.
